(19) United States
(12) Patent Application Publication
(10) Pub. No.: US 2023/0371158 A1
(43) Pub. Date: Nov. 16, 2023

(54) HEURISTIC CONFIGURATION FOR COMMISSIONING A WIRELESS LIGHTING CONTROL SYSTEM

(71) Applicant: RAB Lighting Inc., New York, NY (US)

(72) Inventors: Michael Hayes, Woodside, NY (US); Jason Lawrence Oliver, Rye, NY (US); Ross Barna, New York, NY (US)

(21) Appl. No.: 17/744,071

(22) Filed: May 13, 2022

(51) Int. Cl. H05B 47/19; H05B 47/115; H05B 47/17; H05B 47/11; G05B 13/02

(52) U.S. Cl. CPC H05B 47/19; H05B 47/115; H05B 47/17; H05B 47/11; G05B 13/024

(57) ABSTRACT

A lighting controller and methods provide auto-configuration of lighting system behaviors based on the detection of the type of lighting control devices joined to the lighting controller, including motion sensors, daylight sensors, dimmer switches, scene selectors, and other input devices, and based on a heuristic configuration table. Subsequent user selection of configuration options, including based on the configuration table, and manual resetting of the specific configuration settings are also supported by the disclosed lighting controller and methods.

### TECHNICAL FIELD

Embodiments of this disclosure relate generally to wireless lighting control systems, and more particularly to commissioning of wireless lighting control system devices.

### BACKGROUND

After installation, joining lighting devices, including control devices and lighting fixtures, to a lighting controller is only the first step in fully commissioning a wireless lighting control system. A cumbersome, time-consuming task is configuring how lighting devices will function, i.e., the lighting behavior in response to lighting control devices such as sensors, switches, and the like. A configuration solution determines how the lighting devices will function together; for example, the control logic or automation association that is applied to a set of lighting devices that determine what lighting device inputs will turn lighting fixtures on, off, or dimmed.

As such, it was realized by the inventor of the current disclosure that improvements are needed in current lighting control systems that will provide automation of configuration to reduce the technical and time burden on installers and/or users of wireless lighting control systems.

### SUMMARY

Embodiments of the present disclosure provides a lighting controller and methods that provide auto-configuration of lighting system behaviors based on the detection of the type of lighting control devices joined to the lighting controller, including motion sensors, daylight sensors, dimmer switches, scene selectors, and other input devices.

The applicant has discovered that heuristic problem-solving can be used to provide a prevailing configuration solution in a vast majority of installations, greatly streamlining the commissioning process for a lighting system, including wireless lighting systems. Overriding the initial automatic heuristic configuration with specific modifications as desired can be used to address the small minority of installations for which a different configuration solution is desired, for example, by subsequent selection of various configuration options and/or manual resetting of specific configuration settings after the initial heuristic based configuration is set.

A heuristic configuration table provides a default configuration solution for a set of lighting devices based on the particular combination of device types included in the set of lighting devices. The set can be all lighting devices joined to a lighting controller, or all lighting devices joined and assigned to a particular group, for example, a physical space such as a room or other area. The types of lighting devices used in determining the configuration solution may include all lighting control devices, for example: dimmer switch, motion sensor, ambient (daylight) light sensor, and scene selector (a keypad, graphical, or other user interface switch that allows more complex selection than an on/off or dimmer switch). Note that in the illustrative embodiment the existence of lighting fixture(s) in the set is assumed, and the existence of an on/off switch(es) in the set does not alter the configuration solution. Optionally, the types of lighting devices used in determining the configuration solution may additionally or alternatively include the type of lighting fixture included in the set, for example: downlights, panels/troffers, wall packs, stairwell, landscape, flood, area, and the like. Optionally, the area in which one or more lighting devices of the set are installed may additionally or alternatively be used in determining the configuration solution, for example, different areas and/or rooms of a home installation, an office or other commercial installation, and an outdoor installation, including, for example, stairwell, entryway, office, storage, kitchen, bedroom, hallway, warehouse, landscape, parking, and the like.

An illustrative embodiment of a lighting controller for a lighting system, comprises: a memory storing a table of prevailing lighting system behavior configurations; a transceiver for wireless and operatively joining a set of lighting devices with the lighting controller; a processor configured to: determine the types of lighting control devices in the set of lighting devices; select from the table a lighting system behavior configuration for the set of lighting devices based on the combination of types of lighting control devices included in set of lighting devices; and apply the selected lighting system behavior configuration to the lighting controller for controlling the behavior of the set of lighting devices.

The types of lighting control devices included in the table of prevailing lighting system behavior configurations can includes a motion sensor, an ambient light sensor, a dimmer switch, and a scene selector, or a subcombination thereof. The types of lighting control devices included in the table of prevailing lighting system behavior configurations optionally does not includes an on/off switch. The table of prevailing lighting system behavior configurations can be independent of the types of lighting fixtures included in the set of lighting devices.

The table of prevailing lighting system behavior configurations can include optional behavior configurations; the processor can be further configured to provide selection of any of the optional behavior configurations to a user; and the processor can be further configured to provide user manual selection of behavior configurations, thereby overriding at least a portion of the selected lighting system behavior configuration of the lighting controller for controlling the behavior of the set of lighting devices.

The processor can be further configured to enable a user to assign the set of lighting devices into a plurality of groups; the steps to determine, select, and apply can be completed separately for a subset of lighting devices in each of the plurality of groups, thereby enabling the combination of types of lighting control devices included in the subset of lighting devices in each of the plurality of groups to determine the selected lighting system behavior configuration for each of the plurality of groups.

An illustrative embodiment of a method of automatic configuration for a lighting system, comprises: providing a table of prevailing lighting system behavior configurations based on the types of lighting control devices detected in the lighting system; wirelessly joining a set of lighting devices with a lighting controller, the set of lighting devices including at least one lighting control device; determining the types of lighting control devices included in the at least one lighting control device; selecting from the table a lighting system behavior configuration for the set of lighting devices based on the combination of types of lighting control devices included in the at least one lighting control device; and applying the selected lighting system behavior configuration to the lighting controller for controlling the behavior of the set of lighting devices.

The table of prevailing lighting system behavior configurations can be stored in a memory device of the lighting controller. The types of lighting control devices included in the table of prevailing lighting system behavior configurations can include a motion sensor, an ambient light sensor, a dimmer switch, a scene selector, or a subcombination thereof. The types of lighting control devices included in the table of prevailing lighting system behavior configurations optionally does not includes an on/off switch.

The table of prevailing lighting system behavior configurations can be is independent of the types of lighting fixtures included in the set of lighting devices. The method can further include the step of determining the types of lighting fixtures included in at least one lighting fixture; and wherein: the table of prevailing lighting control system configurations of the table are further based on the type of lighting fixtures included in the set of lighting devices; the step of wirelessly joining a set of lighting devices includes at least one lighting fixture; and the step of selecting from the table further includes based on the combination of types of lighting devices included in the at least one lighting control device.

The method can further comprise the steps of: providing optional behavior configurations in the table of prevailing lighting system behavior configurations includes; and providing to a user selection of any of the optional behavior configurations. The method can further comprise the step of: providing to a user manual selection of behavior configurations, thereby overriding at least a portion of the selected lighting system behavior configuration of the lighting controller for controlling the behavior of the set of lighting devices.

The method can further comprise the step of receiving from a user for each of the set of lighting devices assignment into one of a plurality of groups; and wherein the steps of determining, selecting, and applying are completed separately for a subset of lighting devices assed to each of the plurality of groups, thereby enabling the combination of types of lighting control devices included in the subset of lighting devices in each of the plurality of groups to determine the selected lighting system behavior configuration for each of the plurality of groups.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as many different combinations and sub-combinations thereof. All such useful, novel, and inventive combinations and sub-combinations are contemplated herein, it being recognized that the explicit expression of each of these combinations is unnecessary.

### BRIEF DESCRIPTION OF THE DRAWINGS

Some of the figures shown herein may include dimensions or may have been created from scaled drawings. However, such dimensions, or the relative scaling within a figure, are by way of example, and not to be construed as limiting.

FIG. 1 is a schematic block diagram of an illustrative embodiment of a lighting controller used with a wireless lighting system according to the present disclosure; and

FIG. 2 is a flowchart for an illustrative method used with the lighting controller and wireless lighting system of FIG. 1.

### DETAILED DESCRIPTION OF THE ILLUSTRATED EMBODIMENTS

For the purposes of promoting an understanding of the principles of the disclosure, reference will now be made to one or more embodiments, which may or may not be illustrated in the drawings, and specific language will be used to describe the same. It will nevertheless be understood that no limitation of the scope of the disclosure is thereby intended; any alterations and further modifications of the described or illustrated embodiments, and any further applications of the principles of the disclosure as illustrated herein are contemplated as would normally occur to one skilled in the art to which the disclosure relates. At least one embodiment of the disclosure is shown in great detail, although it will be apparent to those skilled in the relevant art that some features or some combinations of features may not be shown for the sake of clarity.

Any reference to “invention” within this document is a reference to an embodiment of a family of inventions, with no single embodiment including features that are necessarily included in all embodiments, unless otherwise stated. Furthermore, although there may be references to benefits or advantages provided by some embodiments, other embodiments may not include those same benefits or advantages, or may include different benefits or advantages. Any benefits or advantages described herein are not to be construed as limiting to any of the claims.

A lighting controller and methods provide auto-configuration of lighting system behaviors based on the detection of the type of lighting control devices joined to the lighting controller, including motion sensors, daylight sensors, dimmer switches, scene selectors, and other input devices, and based on a heuristic configuration table. Subsequent user selection of configuration options, including based on the configuration table, and manual resetting of the specific configuration settings are also supported by the disclosed lighting controller and methods.

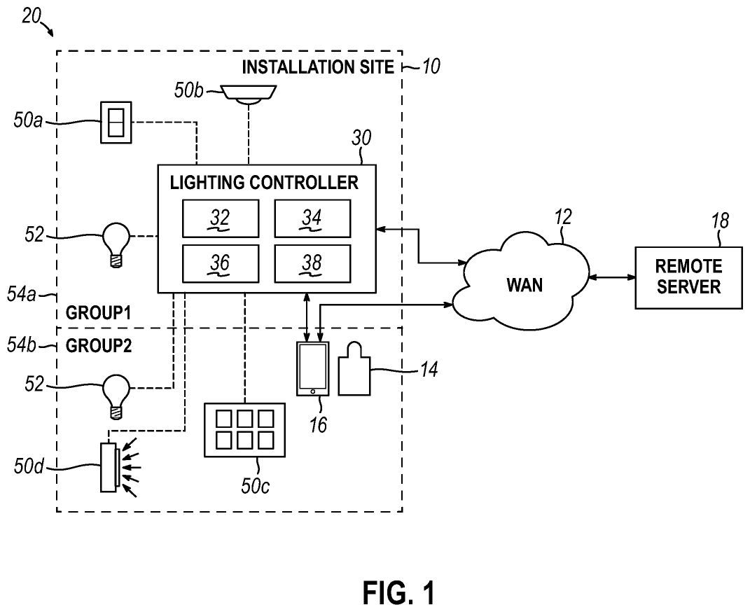

Referring to FIG. 1, an installation site 10 includes an illustrative embodiment of a wireless lighting control system 20, including wireless lighting controller 30, lighting control devices 50, and lighting fixtures 52. The wireless lighting controller 30 can include a processor 32, memory 34, one or more wireless transceivers 36, and optionally a user interface 38. Wireless transceivers 36 may include wireless receivers, transmitters, and/or transceivers, for example, those conforming to known wireless connectivity standards, including for example, but are not limited to, BLUETOOTH (trademark of the Bluetooth SIG, Inc., Kirkland, WA), WI-FI (trademark of the Wi-Fi Alliance, Austin, TX), and ZIGBEE (trademark of the Connectivity Standards Alliance, Davis, CA). The wireless transceivers 36 may optionally support one or more wireless mesh network connectivity standard and can be used to send and receive data with one or more of the lighting devices 50 and 52, a wide area network 12, including for example, the internet and a remote server 18, and a smart device 16 operated by a user 14.

The user 14 may commission, monitor, and control the lighting system 20 via direct communication with the lighting controller 30 via a transceiver (not shown) of the smart device 16 and the wireless transceiver 36 of the lighting controller, and alternatively, via indirect communication, for example via WAN 12, and optionally including communication with a remote server 18 that may provide additional or redundant functionality to that supported locally by lighting controller 30.

Advantageously, the lighting devices 50 and 52 can optionally be divided into groups 54a and 54b, for example, each associated with a different physical of functional area of the installation site 10, for example different rooms in a building. Each group 54a and 54b may also be optionally divided into zones as is known in the lighting control art.

The lighting controller 30 may be, for example, a Lightcloud Hub, available from RAB Lighting Inc. of Northvale, NJ. The lighting control devices 50 may include, for example, but not limited to the following: a dimmer switch 50a, for example a Lightcloud Dimmer, a motion sensor 50b for detecting occupancy and vacancy, for example, a Lightcloud Sensor, a scene selector 50c, for example, a selector panel switch or GUI, for example a Lightcloud Touch, an ambient/daylight sensor 50d, for example a Lightcloud Daylight, and a switch or power sensors (not shown), for example a Lightcloud Controller, all available from RAB Lighting Inc. of Northvale, NJ. The lighting fixtures 52 may be any wireless lighting fixture, for example any Lightcloud Enabled Fixtures, or may be a lighting fixture coupled to and controlled by a wireless controller, for example a Lightcloud Controller, all available from RAB Lighting Inc. of Northvale, NJ. In the illustrative embodiment, the lighting controller 30 is packaged in the physical form of a light switch, such as a dimmer switch, mounted in an electrical switch box, for example, such as a Lightcloud Dimmer, available from RAB Lighting Inc.

Advantageously, a heuristic configuration table 40 (not shown in drawing figures), for example, an illustrative example as listed below, provides a default configuration solution during commissioning of the lighting system 20 that significantly reduces the time and complexity of commissioning the lighting devices 50 and 52 wirelessly joined with the lighting controller 30 in one or more groups 54a and 54b. Advantageously, the default configuration solution may be a prevailing configuration solution for the lighting behavior of wireless lighting system 20 desirable in the vast majority of installation instances.

The default configuration solution for a group 54a or 54b may be selected from the configuration table 40 based on the particular type or combination of types of lighting control devices 50 joined in the group 54, as found for example in the first for columns of table 40, resulting in the default configuration found in the fifth column of table 40. Optionally, the particular type or combination of types of lighting control devices 50 joined in group 54 may also provide from configuration table 40 additional optional behavior configurations the user 18 may selectively apply, for example, as found in the sixth column of table 40. Additionally, the lighting controller 30 may provider the user 18 the option of overriding the default configuration solution and set a different behavior to replace all or a portion of the default configuration solution.

Note that in the illustrative embodiment of the lighting controller 30, the existence of lighting fixtures 52 is assumed and does not impact the configuration solution selected from the configuration table 40, and the existence of one or more on/off switches does not alter the configuration solution. In at least one embodiment, optionally, the type(s) of lighting devices 50 and 52 used in determining the configuration solution may additionally or alternatively include the type of lighting fixture(s) 52 included, for example: downlights, panels/troffers, wall packs, stairwell, landscape, flood, area, and the like, optionally including or alternatively, the area in which one or more lighting devices are installed may be used in determining the configuration solution, for example, different areas and/or rooms of a home installation, an office or other commercial installation, and an outdoor installation, including, for example, stairwell, entryway, office, storage, kitchen, bedroom, hallway, warehouse, landscape, parking, and the like.

ILLUSTRATIVE HEURISTIC CONFIGURATION TABLE 40:

| | 2 | | | | |
|---|---|---|---|---|---|
| 1 | Ambient | 3 | 4 | | |
| Motion | Daylight | Dimmer | Scene | 5 | 6 |
| Sensor | Sensor | Switch | Selector | Default Configuration Solution | Optional Configuration |
| 1x | | | | Sensor controls all zones in group in | Occ/Vacancy/Daylighting |
| | | | | occupancy mode | mode |
| | | | | | Timeout (default 30 mins) |
| | | | | | Sensitivity |
| | | | | | Multiple zone daylighting |
| | | | | | Select which zones are |
| | | | | | closest to → farthest |
| | | | | | from the windows |
| 1x | 1x | | | Occupancy mode: | Sensor mode |
| | | | | Motion Enables daylighting | Target Daylight (fc) |
| | | | | Vacancy mode: | |
| | | | | disables daylighting + turns zones | |
| | | | | off | |
| 2 + x | | | | Sensors are combined into a sensor | Separate sensors |
| | | | | group and control all zones in room in | Vacancy mode |
| | | | | occupancy mode | Other options as per single |
| | | | | | motion sensor |
| | | 1 + x | | Dimmer(s) controls all zones in dim | Customize Dimmer buttons |
| | | | | mode | (i.e. scenes) |
| | | | | If all zones do not dimmable, | Timer |
| | | | | Dimmer controls them in switch | |
| | | | | mode | |
| | | | 1 + x | KEYPAD Buttons | Customize button selections |
| | | | | Dim up | |
| | | | | Dim down | |
| | | | | All On | |
| | | | | All On 50% | |
| | | | | All Off | |
| | | | | TOUCH GUI | |
| | | | | All On | |
| | | | | All Off | |
| | | | | Add each zone in room up to 16 | |
| | | | | zones | |
| 1x | | | 1 + x | Sensor in vacancy mode | |
| | | | | KEYPAD buttons/TOUCH as above | |
| | 1x | | | Sensor controls all zones in | Multiple zone daylighting |
| | | | | Daylighting mode | Select which zones are |
| | | | | | closest to → farthest |
| | | | | | from the windows |
| 1x | | 1x | | Default: Sensor in vacancy mode: | Occ/Vac/Daylighting mode |
| | | | | Dimmer controls all zones in room | Timeout |
| | | | | Sensor in occupancy mode: | Sensitivity |
| | | | | Sensor controls all zones in room | Manual override time out |
| | | | | Dimmer off button turns zones off | |
| | | | | via manual override | |
| | | | | Sensor in Daylighting mode: | |
| | | | | Vacancy disables | |
| | | | | Occupancy enables automation | |
| 1x | 1x | 1x | | Default: sensor in vac mode: | Sensor mode & params |
| | | | | Dimmer on enables daylighting | Target Daylight (fc) |
| | | | | Dimmer off disables daylighting + | Manual Override timeout |
| | | | | zones off | |
| | | | | Sensor in occ mode: | |
| | | | | Dimmer dims via manual override | |
| | 1x | 1x | | Sensor controls all zones in - | |
| | | | | Daylighting mode | |
| | | | | Dimmer Top button | |
| | | | | enables Daylighting automation | |
| | | | | Dimmer Bottom button | |
| | | | | disables Daylighting automation | |
| | | | | turns zones off | |

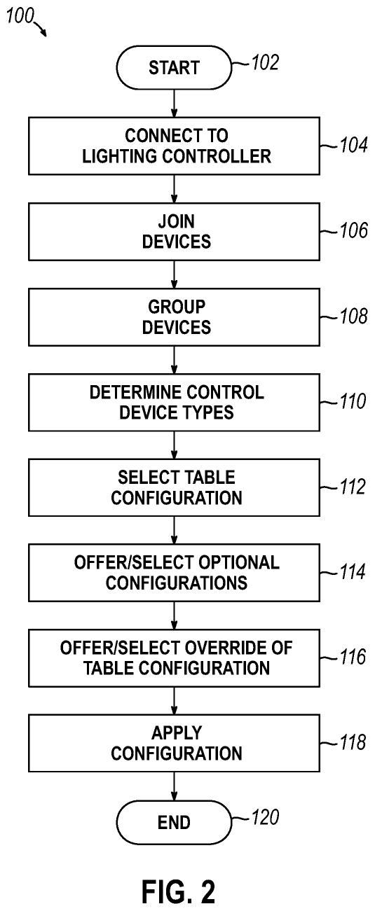

FIG. 2 is a flowchart of an illustrative method, process 100, which can be implemented by the lighting controller 30 in the illustrative lighting system 20. The process 100 is generally enabled by processor 32 of the lighting controller 30, and may also optionally include smart device 16 and remote server 18 to enable any of the steps. For example, smart device 16 may include an application that interacts with one or both of lighting controller 30 and remote server 18 to enable process 100. One of memory 34 of the lighting controller 30, the smart device 16, or the remote server 18, stores a table of the prevailing lighting system behavior configurations, for example, data enabling the logic of Table 40 above.

At step 102, the process 100 begins. At step 104, optionally, a user 14 uses a smart device 16 to wirelessly connect to the lighting controller 30 and interact with the process 100 steps. At step 106, the process 100 joins newly installed lighting devices 50 and 52 to the lighting controller 30, for example, in response to user 14 initiating the joining process via smart device 16. At step 108, the user 14 can optionally divide the joined lighting devices 50 and 52 into groups, for example group 1 and group 2 as illustrated in FIG. 1, each group may be associated with an area, for example a different room or other portions of a building environment for which it is desirable to operate the lighting devices 50 and 52 as a group. Optionally, user may also establish lighting zones within one or more groups.

At step 110, the process 100 determines the types of lighting control devices 50 present in each group, for example, but not limited to, of the types illustrated in columns one through four of Table 40. At step 112, the process 100 selects a prevailing lighting system behavior configuration, for example, by selecting a row of Table 40 based on the combination of lighting control devices 50 of columns one through four found in each group and matching that to one of the rows of Table 40, then obtaining the prevailing configuration from the matching row. For example, referring to table 40, if the control devices 50 present in a group are a motion sensor and an ambient daylight sensor, the second row will be selected as the match and the behavior applied to the lighting group is: upon the motion sensor sensing occupancy, daylighting is enabled, and upon the motion sensor sensing vacancy, daylighting is disabled and any lighting zones are turned off. Daylighting is activating lighting fixtures 52 by using the ambient daylight sensor to determine the level of light required from the lighting fixtures to provided a desired light level.

At step 114, the process 100 may offer to user 14 the smart device 16 selection of optional configurations, for example, from column six of the matching row of Table 40 identified in step 112. For example, in matching row two of Table 40, the optional configuration selections are the primary operating mode of occupancy or vacancy for the lighting control device 50 comprising a motion sensor, and the desired lighting level to use for the daylighting behavior feature and the lighting control device 50 comprising a ambient daylight sensor. At step 116, the process 100 may offer the option to override and manually select any portion or all of the prevailing behavior configuration selections. At step 118, the process 100 applies the behavior configuration resulting from the above steps, for example, by storing the configuration in memory 34 of the lighting controller 30, enabling the processor 32 to control the lighting devices 50 and 52 accordingly. At step 120, the process 100 is complete.

It should be understood that the above description is intended for illustrative purposes only and is not intended to limit the scope of the present disclosure in any way. Thus, those skilled in the art will appreciate that other aspects of the disclosure can be obtained from a study of the drawings, the disclosure and the appended claims.

Reference systems that may be used herein can refer generally to various directions (e.g., upper, lower, forward and rearward), which are merely offered to assist the reader in understanding the various embodiments of the disclosure and are not to be interpreted as limiting.

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used in combination with some or all of the features of other embodiments as would be understood by one of ordinary skill in the art, whether or not explicitly described as such. One or more exemplary embodiments have been shown and described, and all changes and modifications that come within the spirit of the disclosure are desired to be protected.

What is claimed is:

1. A lighting controller for a lighting system, comprising:
a memory storing a table of prevailing lighting system behavior configurations;
a transceiver for wireless and operatively joining a set of lighting devices with the lighting controller;
a processor configured to:
determine the types of lighting control devices in the set of lighting devices;
select from the table a lighting system behavior configuration for the set of lighting devices based on the combination of types of lighting control devices included in set of lighting devices; and
apply the selected lighting system behavior configuration to the lighting controller for controlling the behavior of the set of lighting devices.

2. The lighting controller of claim 1, wherein the types of lighting control devices included in the table of prevailing lighting system behavior configurations includes a motion sensor.

3. The lighting controller of claim 1, wherein the types of lighting control devices included in the table of prevailing lighting system behavior configurations includes an ambient light sensor.

4. The lighting controller of claim 1, wherein the types of lighting control devices included in the table of prevailing lighting system behavior configurations includes a dimmer switch.

5. The lighting controller of claim 1, wherein the types of lighting control devices included in the table of prevailing lighting system behavior configurations includes a scene selector.

6. The lighting controller of claim 1, wherein the types of lighting control devices included in the table of prevailing lighting system behavior configurations does not includes an on/off switch.

7. The lighting controller of claim 1, wherein the table of prevailing lighting system behavior configurations is independent of the types of lighting fixtures included in the set of lighting devices.

8. The lighting controller of claim 1, wherein:
the table of prevailing lighting system behavior configurations includes optional behavior configurations;
the processor is further configured to provide selection of any of the optional behavior configurations to a user; and
the processor is further configured to provide user manual selection of behavior configurations, thereby overriding at least a portion of the selected lighting system behavior configuration of the lighting controller for controlling the behavior of the set of lighting devices

9. The lighting controller of claim 1, wherein:
the processor is further configured to enable a user to assign the set of lighting devices into a plurality of groups;
the steps to determine, select, and apply are completed separately for a subset of lighting devices in each of the plurality of groups, thereby enabling the combination of types of lighting control devices included in the subset of lighting devices in each of the plurality of groups to determine the selected lighting system behavior configuration for each of the plurality of groups.

10. A method of automatic configuration for a lighting system, comprising:
providing a table of prevailing lighting system behavior configurations based on the types of lighting control devices detected in the lighting system;
wirelessly joining a set of lighting devices with a lighting controller, the set of lighting devices including at least one lighting control device;
determining the types of lighting control devices included in the at least one lighting control device;
selecting from the table a lighting system behavior configuration for the set of lighting devices based on the combination of types of lighting control devices included in the at least one lighting control device; and
applying the selected lighting system behavior configuration to the lighting controller for controlling the behavior of the set of lighting devices.

11. The method of claim 10, wherein the table of prevailing lighting system behavior configurations is stored in a memory device of the lighting controller.

12. The method of claim 10, wherein the types of lighting control devices included in the table of prevailing lighting system behavior configurations includes a motion sensor.

13. The method of claim 10, wherein the types of lighting control devices included in the table of prevailing lighting system behavior configurations includes an ambient light sensor.

14. The method of claim 10, wherein the types of lighting control devices included in the table of prevailing lighting system behavior configurations includes a dimmer switch.

15. The method of claim 10, wherein the types of lighting control devices included in the table of prevailing lighting system behavior configurations includes a scene selector.

16. The method of claim 10, wherein the types of lighting control devices included in the table of prevailing lighting system behavior configurations does not includes an on/off switch.

17. The method of claim 10, wherein the table of prevailing lighting system behavior configurations is independent of the types of lighting fixtures included in the set of lighting devices.

18. The method of claim 10, further comprising the step of:
determining the types of lighting fixtures included in at least one lighting fixture; and wherein:
the table of prevailing lighting control system configurations of the table are further based on the type of lighting fixtures included in the set of lighting devices;
the step of wirelessly joining a set of lighting devices includes at least one lighting fixture; and
the step of selecting from the table further includes based on the combination of types of lighting devices included in the at least one lighting control device.

19. The method of claim 10, further comprising the steps of:
providing optional behavior configurations in the table of prevailing lighting system behavior configurations includes; and
providing to a user selection of any of the optional behavior configurations.

20. The method of claim 10, further comprising the step of:
providing to a user manual selection of behavior configurations, thereby overriding at least a portion of the selected lighting system behavior configuration of the lighting controller for controlling the behavior of the set of lighting devices.

21. The method of claim 10, further comprising the step of receiving from a user for each of the set of lighting devices assignment into one of a plurality of groups; and wherein the steps of determining, selecting, and applying are completed separately for a subset of lighting devices assed to each of the plurality of groups, thereby enabling the combination of types of lighting control devices included in the subset of lighting devices in each of the plurality of groups to determine the selected lighting system behavior configuration for each of the plurality of groups.
